(19) United States
(12) Patent Application Publication
(10) Pub. No.: US 2007/0221191 A1
(43) Pub. Date: Sep. 27, 2007

(54) Outdoor oven

(76) Inventors: Iris C. O'Brien, Birmingham, AL (US); David L. Crawley, Birmingham, AL (US)

Correspondence Address: IRIS C. O'BRIAN, 8005 CASTLE HILL RD, HOOVER, MD, 35242, US

(21) Appl. No.: 11/371,829

(22) Filed: Mar. 8, 2006

(51) Int. Cl. F24B 3/00; A47J 37/00

(52) U.S. Cl. 126/25 R

(57) ABSTRACT

An outdoor oven adapted for use as an old-world style brick oven, a traditional gas grill, or a traditional charcoal grill. The outdoor oven comprises a cooking chamber, at least one gas burner positioned below the cooking chamber, a thermostat operatively connected to the burners for controlling the temperature of the cooking chamber when operated in the oven mode, means for positioning at least one removable cooking tile above the burner, a subfloor mounted to the oven housing between the burner and the cooking chamber. The subfloor has a plurality of openings formed therein through which heated air flows upward toward the bottom surface of the cooking tiles from the burners; and at least one removable insert portion and an outer portion mounted to the oven housing. The oven further provides means for supporting at least one removable grill rack above the burner for use when operated in the grill mode with the cooking tiles and removable insert of the subfloor removed.

### FIELD OF THE INVENTION

The present invention relates to an outdoor oven. With greater particularity, the present invention relates to a portable, outdoor gas-powered oven and grill.

### BACKGROUND OF THE INVENTION

There has long been a need for a portable oven that can be used outdoors for both grilling and baking. Outdoor cooking and the use of outdoor kitchens are increasingly popular because outdoor kitchens provide a gathering place for families and friends and fits with other outdoor activities, particularly during periods of good weather. Outdoor kitchen and dining areas also provide significant value to homes, both in the quality of life offered and the value and distinctiveness of the home in the real estate market.

Heretofore, outdoor cooking has been largely limited to the use of conventional gas barbecue grills. While grilling is expected to maintain its popularity, the usefulness of outdoor kitchens is greatly enhanced by the opportunity to cook a wider variety of food than provided by conventional gas grills. Some foods are best cooked in ovens of the style of old-world brick ovens, such as wood-fired pizzas as well as a wide variety of healthy foods such as roasted vegetables and hearth baked breads. There is a long-felt need for ovens that allow these foods to be prepared without using large and expensive commercial brick ovens.

In an outdoor kitchen, it is desirable to reduce the number of separate components, grills and ovens while at the same time maintaining the ability to cook a wide variety of foods. In many instances the space allocated to an outdoor kitchen is limited. To conserve space and reduce expenses, there is a need to provide a single outdoor unit (oven) that overcomes the limitations in the prior art, namely, an outdoor oven that may be readily used as either a traditional gas grill, a traditional charcoal grill, a conventional oven, as well as an old-world style brick oven. There is a need for an inexpensive and lightweight portable outdoor oven that provides the functionality of a traditional brick oven and traditional gas grill. There is an additional need for an oven that can be utilized not only for cooking, but also as a fireplace to enhance the usefulness and comfort of outdoor kitchens and gathering places.

From the foregoing it may be seen that heretofore, no one has provided a portable outdoor oven that adequately provides for use as both a traditional gas grill, a conventional oven, and a traditional brick oven. A need exists for an oven that overcomes the limitations of the prior art, thereby encouraging the use of outdoor kitchens as a gathering place for family and friends.

### SUMMARY OF THE PRESENT INVENTION

It is an object of the present invention to provide an improved outdoor oven.

Another object of the present invention is to provide an outdoor oven that may be readily used as a traditional gas grill, a traditional charcoal grill, or a conventional/traditional brick oven.

An additional object of the present invention is to provide an inexpensive oven that may be used in outdoor kitchens.

A still further object of the present invention is to provide a portable and lightweight outdoor oven.

An additional object of the present invention is to provide an outdoor oven that can be used as a wood-burning fireplace.

Another object of the present invention is to provide an outdoor gas oven having a thermostat for controlling the temperature in the cooking chamber.

A still further object of the present invention is to provide an improved method for heating a cooking chamber in an outdoor oven (traditional brick oven).

An additional object of the present invention is to provide an outdoor gas oven that is safe and easy to use.

These and other objects of the present invention are accomplished through the use of an outdoor oven having a cooking chamber positioned above at least one gas burner. The oven is configured for use in one of several modes. In the oven mode, a cooking floor having an upper cooking surface is provided by one or more removable ceramic tiles. The outer edge of the cooking floor is in conforming contact with the inner edge of a lip member mounted within the cooking chamber. The lip member is positioned in spaced apart relationship to the wall of the cooking chamber to provide for a passageway therebetween through which heated air rises into the cooking chamber. The cooking floor may be a single ceramic cooking tile shaped to fit in conforming contact with the lip member or, alternatively, a plurality of cooking tiles having an outer edge shaped to fit in conforming contact with the lip member. It may be appreciated that the lip member, a portion of which rises above the top cooking surface, provides a barrier to prevent food from falling off the cooking surface along its edge downward into the oven housing or gas burner box. The lip member also serves to hold the plurality of cooking tiles in abutting relationship to one another to provide for a substantially contiguous cooking surface. Additionally, the lip member serves to direct the flow of rising heat to the oven's internal surfaces which provides for even temperature distribution throughout the range of operating temperatures. This also yields an even inner surface wall temperature in the chamber which in turn provides even radiant heat to the inner chamber once fuel temperatures are reduced.

Below the cooking floor and positioned in spaced apart relationship therefrom is a subfloor mounted to the oven housing between the gas burner and the cooking chamber. The subfloor has a plurality of openings through which heated air rises from the gas burner into an air channel between the subfloor and cooking floor. The present invention comprises a spacing means for maintaining the subfloor and cooking floor apart to provide for an air channel therebetween. Spacing means may comprise a plurality of spacers fixedly attached to the top surface of the subfloor onto which the tiles comprising the cooking floor are placed. The space between the subfloor and cooking floor is maintained along the outer edge of the cooking floor to allow heated air to flow from the air channel through a plurality of slots formed in the lip member between the cooking floor and the subfloor. This may also be accomplished by resting or affixing the bottom edge of the lip member to the top surface of the spacers so that the spacing means maintains the lip member apart from the subfloor in a similar manner as the cooking floor.

When the present invention is operated in the oven mode, heated air rises from the burners and through the openings in the subfloor and into the air channel formed by the bottom of the cooking floor and the top of the subfloor. The heated air is directed in this manner to the bottom surface of the tiles forming the cooking surface whereupon the cooking surface is heated. The burners are located within a burner box positioned below the subfloor which is adapted for directing the flow of heated air upward from the burners to the openings in the subfloor. Having entered the air channel, the heated air then emanates outward through the air channel towards the outer edge of the cooking floor, where it exits the air channel. As described herein, the heated air exits the air channel either through slots formed in the lip member at a height between the top of the subfloor and the bottom of the cooking tiles, or alternatively under the lip member. Upon exiting the air channel, the heated air then moves upward through the passageway between the lip member and the wall or inner surface of the cooking chamber, whereupon the cooking chamber is subsequently heated. The heated air maintains the cooking temperature in the cooking chamber before it exits the oven through a chimney formed in an upper portion of the cooking chamber.

For use in operating in the oven mode, the present invention is provided with thermostatic means well known in the art for controlling the temperature in the cooking chamber. Namely, a thermostat is operatively connected to the gas burners for use in adjusting the heat output of the burners as needed to maintain a constant temperature in the cooking chamber. The present invention also has means for lighting the burner comprising an igniter button and means for setting the desired temperature in the cooking chamber comprising a burner control knob. The present invention may also include a temperature gauge mounted on the outer surface of the oven housing for use in visually determining the current temperature in the cooking chamber.

The present invention may be portable, and in the preferred embodiment is provided with at least two wheels mounted to the oven housing to allow for movement of the oven. This may be in the form of heavy-duty casters attached to the bottom of the oven housing. The cooking chamber is insulated along its top and sides to reduce energy consumption and maintain a steady temperature in the cooking chamber. The present invention has the advantage of reduced initial heating time compared to conventional brick ovens, the cooking chamber of the present invention reaches the desired cooking temperature much faster than conventional brick ovens. To enhance the portability of the present invention in comparison with traditional brick ovens, the cooking chamber is insulated with lightweight insulating material such as heat resistant fibers or lightweight refractory. In this manner the present invention provides a portable outdoor oven that may be used to cook food heretofore available only in restaurants with large, expensive brick ovens. To aid in controlling the temperature in the cooking chamber, the present invention is provided with a damper positioned within an exhaust chimney. The damper is designed such that it is closed when operating in the oven mode, which allows a controlled amount of heat to exit and opened in all other modes.

The present invention may be readily converted from use as an outdoor oven to use as a traditional gas grill. The cooking tiles comprising the cooking floor are simply removed to expose the top surface of the subfloor. The subfloor is provided with one or more centrally-located removable insert portions. These insert portions are also removed, which exposes one or more grill racks positioned thereunder. Alternatively, the grill rack may then be placed on the subfloor, or otherwise secured to the oven housing, to cover the opening formed by the removal of the insert portions. The grill rack is thus supported in a position directly above the gas burners to allow for use of the gas burners to cook food on the grill rack in the traditional manner of a gas grill. The present invention may also be provided with a warming rack (not shown) within the cooking chamber above the grill rack. The burners are provided with a fuel gas supply such as a conventional residential source of natural gas or propane tank. When a propane tank is used, the tank may be positioned proximate the burners either adjacent to the oven or, alternatively, enclosed within the lower portion of the oven housing.

It may be appreciated that conversion of the invention from the oven mode to the grill mode is accomplished by simply removing the cooking tiles and the insert portion of the subfloor from the oven to expose a grill rack. The grill rack, which is removable for cleaning, is already in place having been positioned directly below the insert portion of the subfloor. In the alternative, the grill rack may be placed in the oven upon removal of the insert portion. The oven is provided with a removable door hingedly connected to the oven housing using connecting structures (not shown) that are well known in the art, including but not limited to one or more vertically oriented tubular receivers affixed to the housing, the receivers being adapted for slidingly receiving corresponding downwardly oriented vertical pins connected to the door. In the gas grill mode, the door is removed from the oven housing, the damper is opened, and the burners are not used.

The present invention may also be converted for use as a traditional charcoal grill. The invention provides means for holding a metal box between the burners and the grill rack, namely, a removable charcoal box rack positioned in the burner box onto which an appropriately shaped metal box may be placed. Conversion from the gas grill mode to the charcoal grill mode is accomplished by turning off the gas burners and removing the grill rack to provide access for placing the charcoal box rack in the burner box below the grill rack. A metal box is then placed onto the top surface of the charcoal box rack, and the grill rack is then replaced. In the charcoal mode, the door is removed from the oven housing, the damper is opened, and the burners are not used. Instead, the metal box is filled with charcoal and lit for use in grilling food on the grill rack positioned above the metal box. Upon completion of cooking in the charcoal grill mode, the metal box may be removed from the oven for cleaning and to allow use of the present invention in the oven and gas grill modes.

The present invention may also be converted for use as an outdoor fireplace. When the oven is used as a fireplace, the damper is opened, the door is removed from the oven housing, and the burners are not used. Instead, the oven is generally placed in the configuration of the oven mode with the cooking tiles in place in the cooking chamber to form a cooking floor. A metal box containing a removable log rack is then placed on the cooking floor. Wood and other materials may then be placed onto the log rack and lit to create a fire within the cooking chamber. This allows light and heat from the fire to emanate from the oven through the door opening. The log rack may be placed either directly on the cooking floor or within a metal box placed on the cooking floor to allow for collection of ashes from the materials burning on the log rack.

These and other objects and advantages of the invention will become apparent from the following detailed description of the preferred embodiment of the invention.

### BRIEF DESCRIPTION OF THE DRAWINGS

An outdoor oven embodying the features of the present invention is depicted in the accompanying drawings which form a portion of this disclosure and wherein:

FIG. 1 is a perspective view of the preferred embodiment of an outdoor oven;

FIG. 2 is an exploded view of the preferred embodiment of an outdoor oven;

FIG. 3 is a partial sectional view of the preferred embodiment of an outdoor oven, taken along the lines 3-3 of FIG. 12.

FIG. 4 is a perspective view of the subfloor and lip member;

FIG. 5 is a perspective view of the subfloor, lip member, and cooking floor;

FIG. 6 is a perspective view of the grill rack and the outer portion of the subfloor;

FIG. 7 is an exploded view of the preferred embodiment of an outdoor oven showing a charcoal box rack and metal box;

FIG. 8 is a front elevational view of the preferred embodiment of an outdoor oven operating in the fireplace mode;

FIG. 9 is a second perspective view of the preferred embodiment of an outdoor oven;

FIG. 10 is a front elevational view of the preferred embodiment of an outdoor oven;

FIG. 11 is a rear elevational view of the preferred embodiment of an outdoor oven;

FIG. 12 is a left side elevational view of the preferred embodiment of an outdoor oven;

FIG. 13 is a right side elevational view of the preferred embodiment of an outdoor oven;

FIG. 14 is a bottom view of the preferred embodiment of an outdoor oven; and,

FIG. 15 is a top plan view of the preferred embodiment of an outdoor oven.

### DESCRIPTION OF THE PREFERRED EMBODIMENT

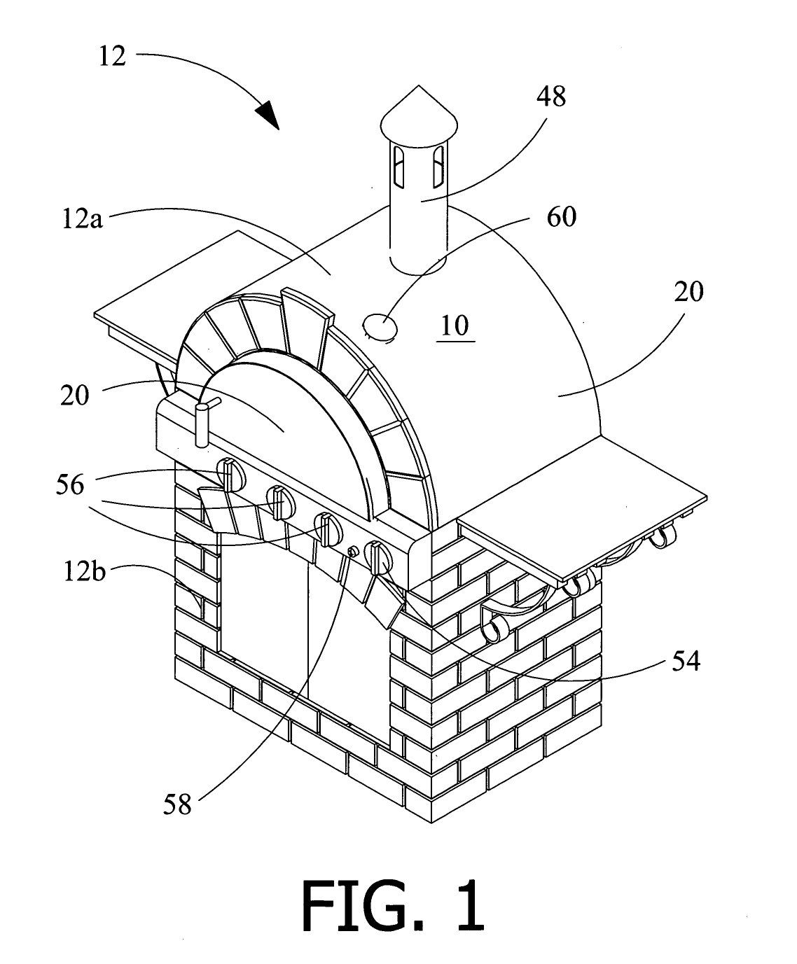

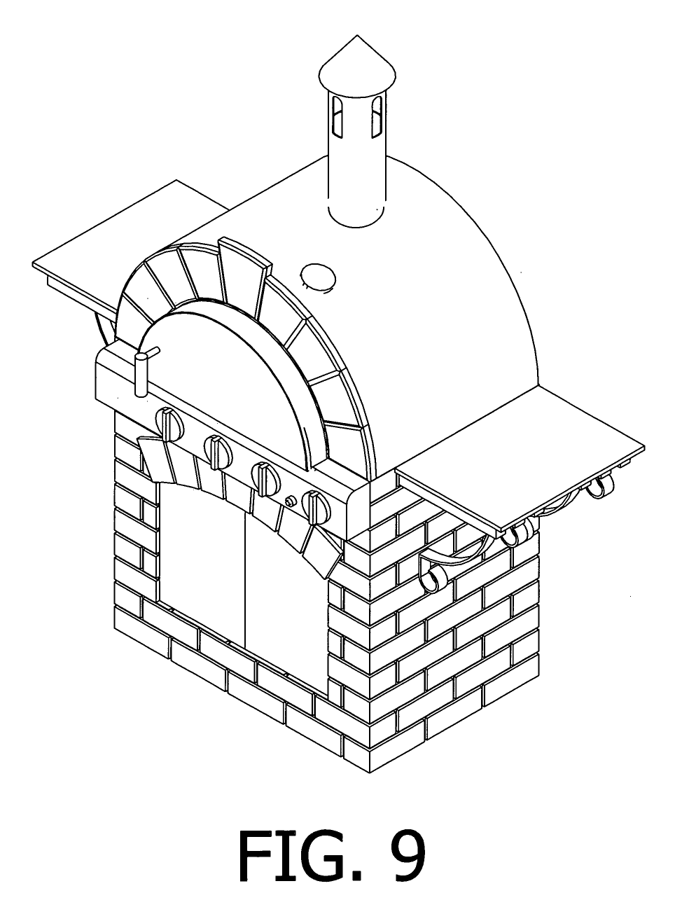

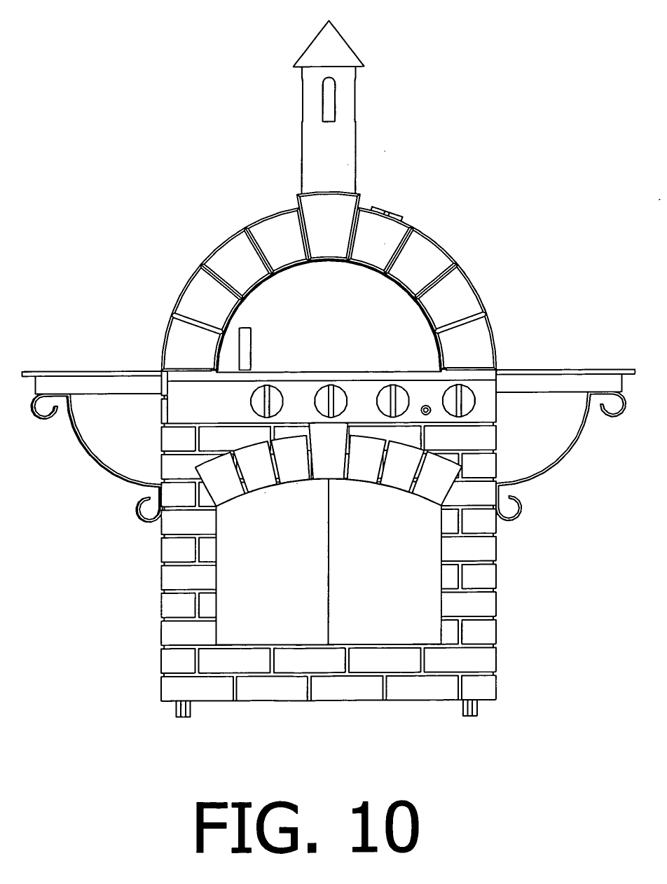

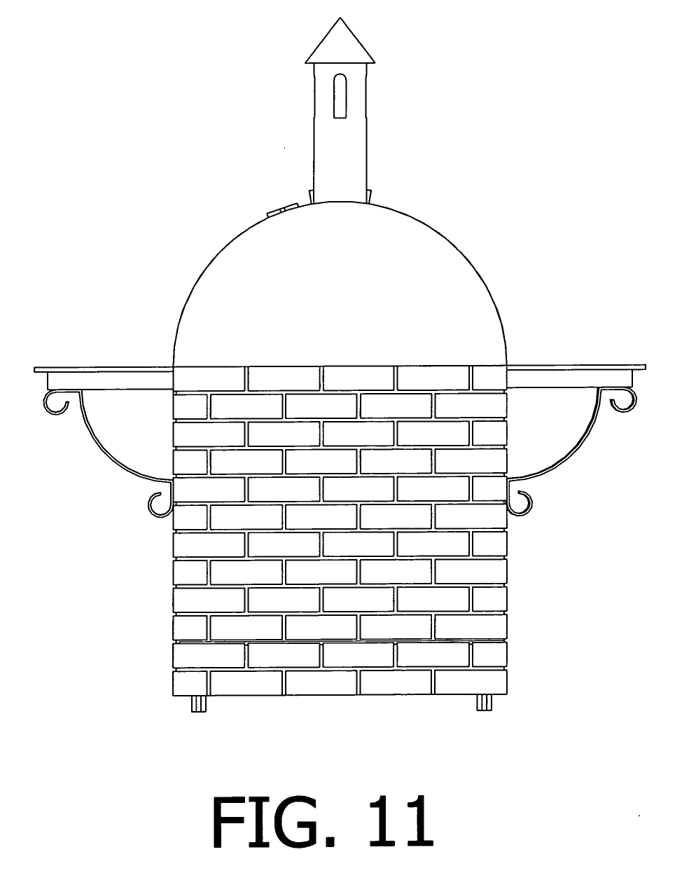

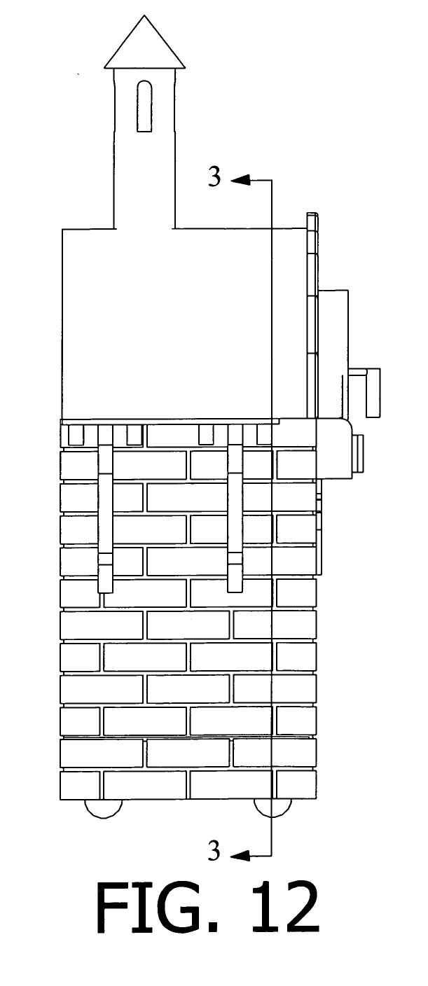

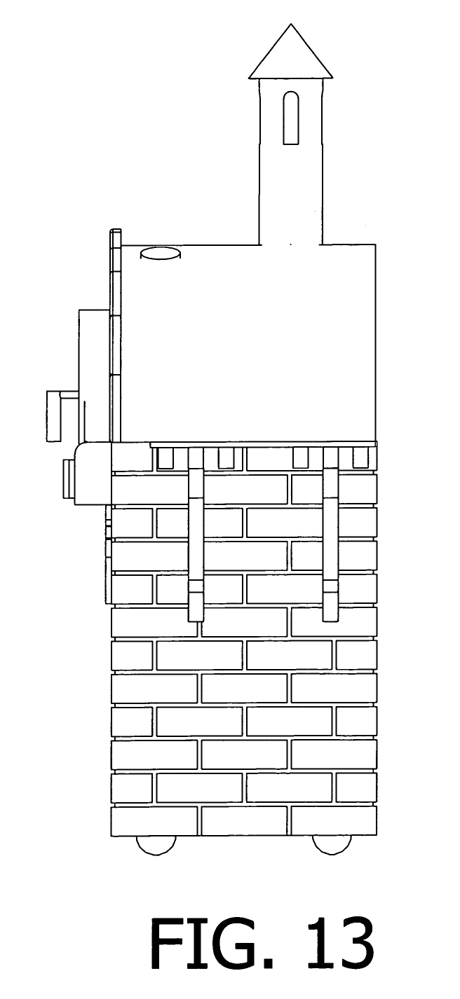

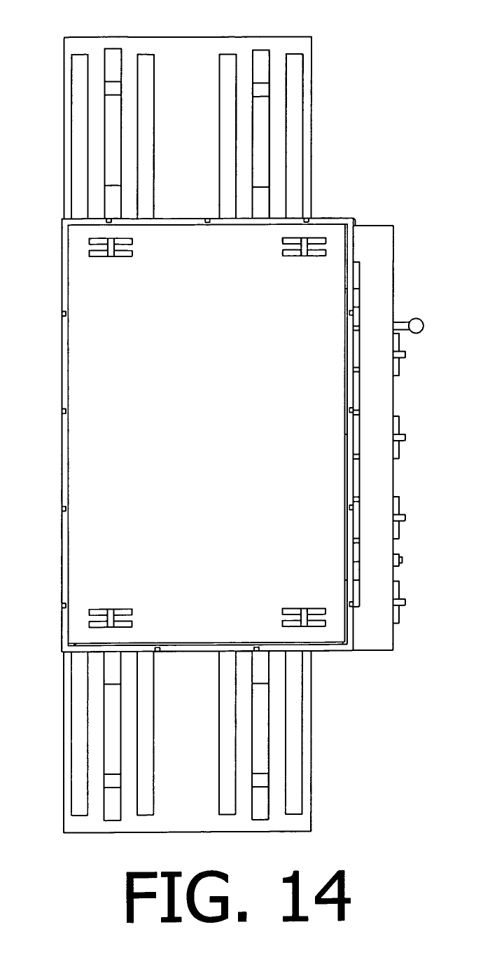

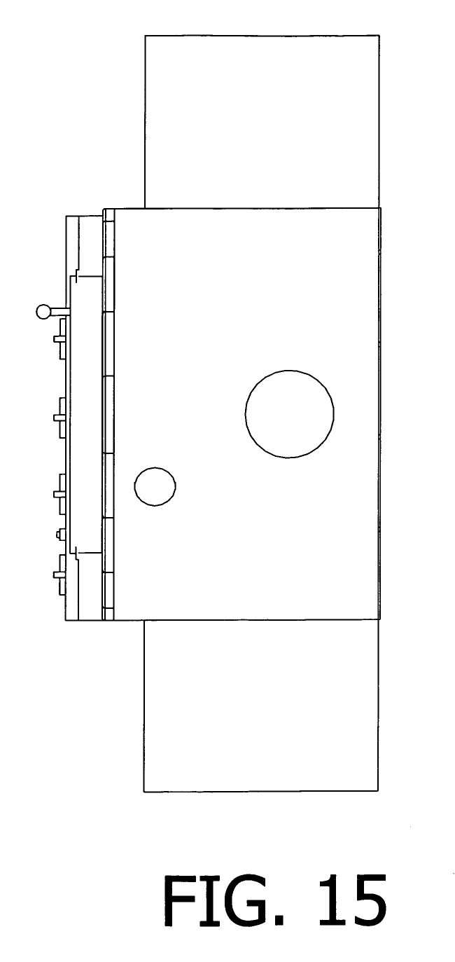

Referring to FIGS. 1-15 for a clearer understanding of the invention, it may be seen that the preferred embodiment of the outdoor oven 10 comprises a housing 12 having an upper portion 12a forming an internal cooking chamber 14 and a lower portion 12b enclosing at least one gas burner 16 positioned within the lower portion 12b below the cooking chamber 14. The burners 16 are provided with a fuel gas supply such as a conventional residential source of natural gas or propane tank (not shown). When used with a propane tank, the tank is positioned near the burners 16 either adjacent to the oven 10 or alternatively, enclosed within the lower portion 12b of the oven housing.

In the preferred embodiment, the outdoor oven 10 is portable and may be readily relocated with the assistance of at least two wheels 18 mounted to the oven housing 12. In the preferred embodiment, the wheels 18 are provided in the form of four casters 18 attached to the bottom of the oven housing 12 to allow the housing 12 to be moved. To enhance the portability of the oven 10 in comparison with traditional brick ovens, the cooking chamber 14 is insulated with lightweight material (not shown). The oven 10 comprises lightweight insulating material surrounding the top and sides of the cooking chamber 14. In the preferred embodiment, lightweight insulating material is in the form of high heat resistance cotton fiber material placed in voids formed in the upper portion 12a of the housing surrounding the cooking chamber 14 as well as voids formed in an oven door 20 connected to the housing. Although the preferred embodiment discloses the use of high heat resistance cotton fiber material, it is contemplated that other lightweight insulating materials well known in the art such as lightweight refractory may used without departing from the scope of the present invention. The oven 10 is provided with a removable door 20 hingedly connected to the oven housing 12 using connecting structures (not shown) that are well known in the art, including but not limited to one or more vertically oriented tubular receivers affixed to the housing, which are adapted for slidingly receiving corresponding downwardly oriented vertical pins attached to the door 20.

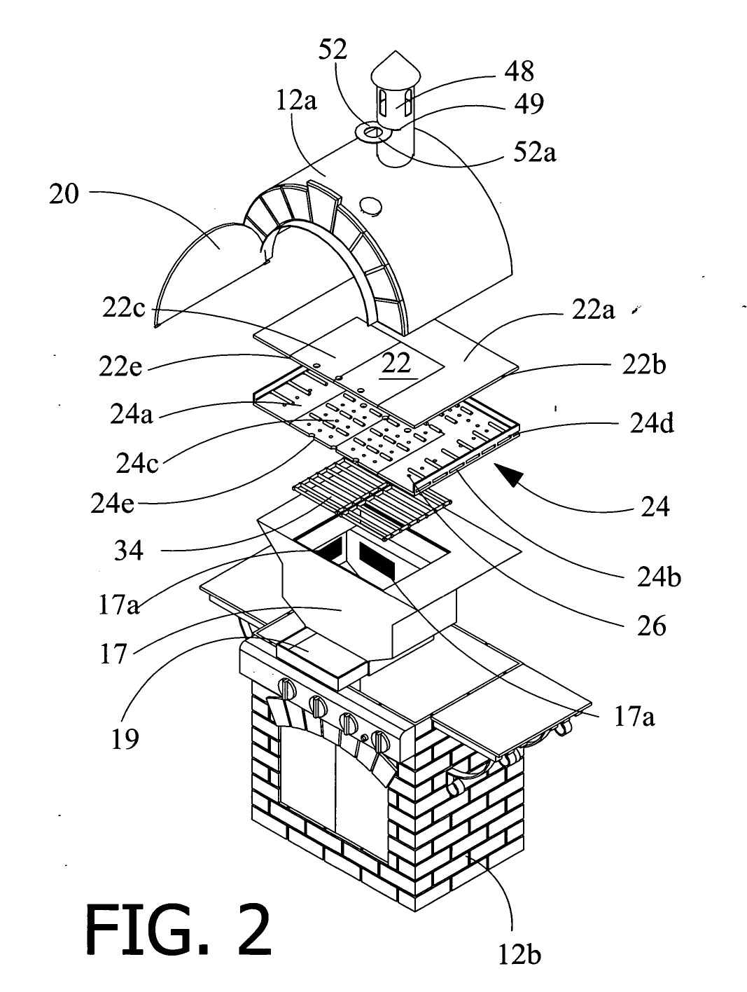

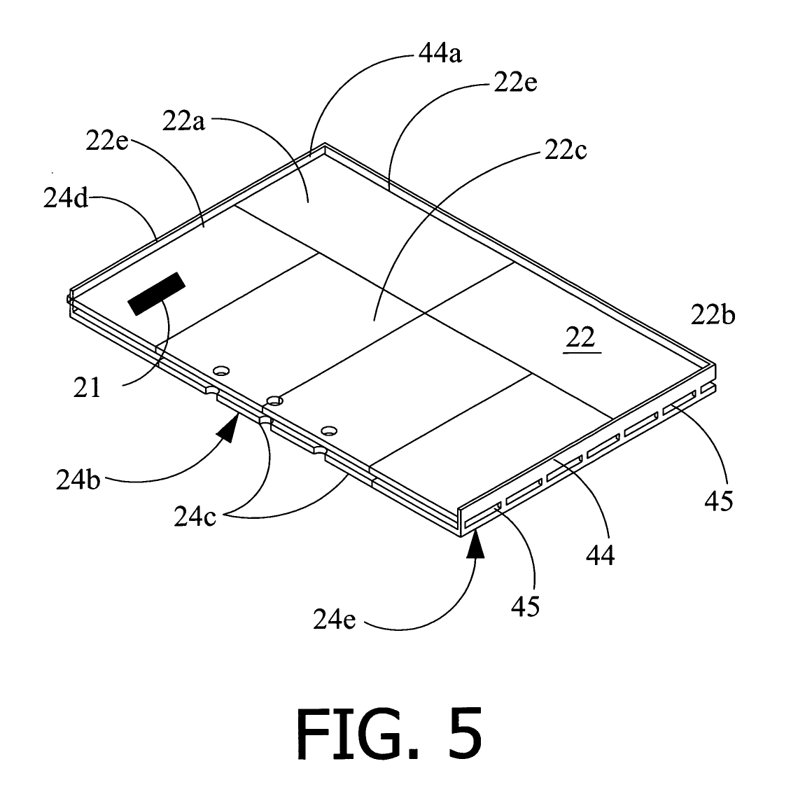

For use in operating the present invention as an outdoor oven, a removable ceramic cooking floor 22 as shown in FIG. 2 is provided comprising at least one removable cooking tile 22 having an upper surface 22a and a bottom surface 22b. The upper surface 22a is a cooking surface used for baking food within the cooking chamber 14. As shown in FIG. 5, the present invention provides a ceramic floor 22 in the form of six ceramic rectangular tiles. While all of the tiles 22 are removable, two centrally-located tiles 22c in the preferred embodiment may be more easily moved than the others to take cooked food such as a pizza from the oven 10 for serving. It is contemplated that the ceramic floor 22 may be provided in the form of a single removable tile. Although the preferred embodiment discloses the use of a ceramic floor and tiles 22 having a rectangular shape, it is contemplated that other configurations such as but not limited to circular configurations of tiles 22 may used without departing from the scope of the present invention. The present invention may also be provided with a chute (not shown) having a chute opening 21 formed in the cooking surface 22 as shown in FIG. 5. The chute would provide an inclined passage through which debris on the cooking surface could be directed downward to a drip tray 19 located below the burners 16.

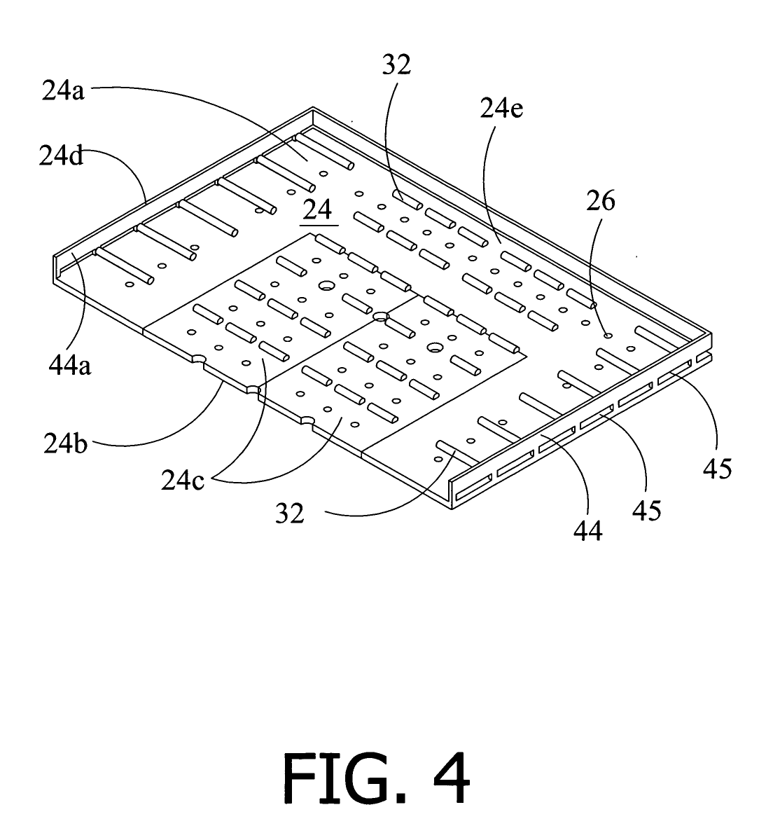

The present invention provides means for positioning at least one removable cooking tile 22 above the burner 16. In the preferred embodiment, the means for positioning is provided by a metallic subfloor 24 mounted to the housing 12 between the burner 16 and the cooking chamber 14. The metallic subfloor 24 has a plurality of openings 26 formed therein through which heated air flows upward toward the bottom surface 22b of the cooking tiles from the burners 16. The subfloor 24 further comprises at least one centrally-located removable insert portion 24c and an outer portion 24d that is mounted to the oven housing 12. As shown in FIG. 4, the preferred embodiment provides a subfloor 24 having two rectangular insert portions 24c and a u-shaped outer portion 24d.

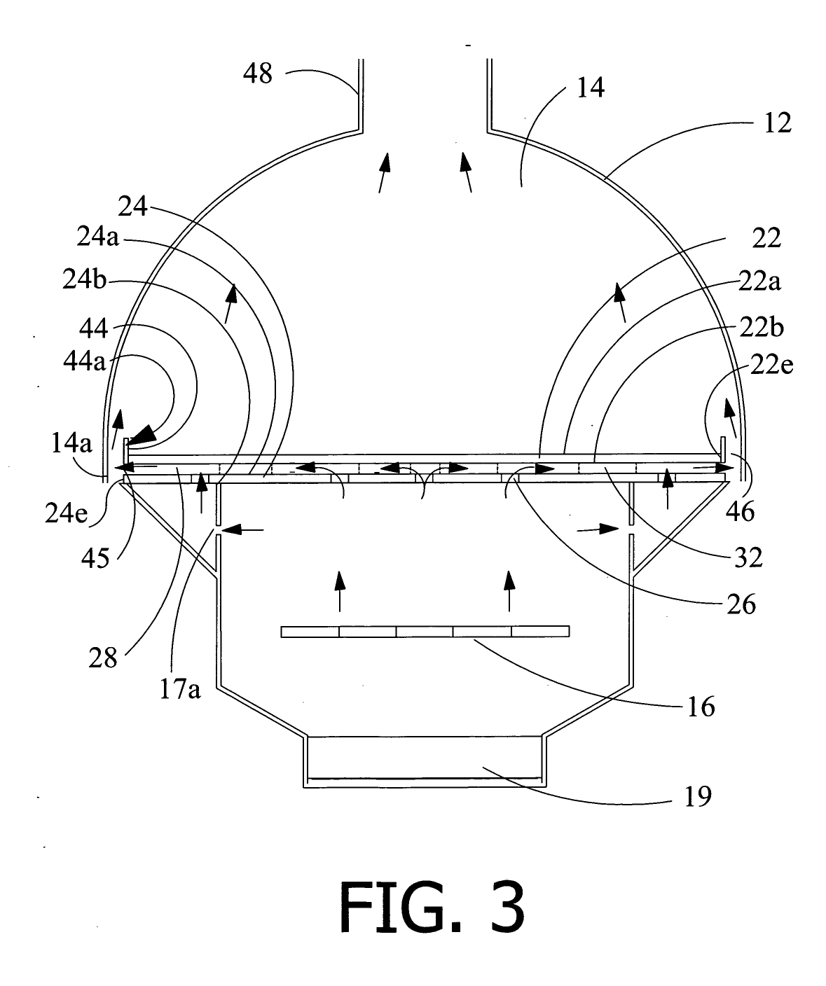

The cooking floor and tiles 22 are positioned above the subfloor 24 in spaced apart relationship of at least about ⅛ of an inch, and more preferably of at least about ¼ of an inch. The present invention includes spacing means for creating an air channel 28 between the bottom surface 22b of the cooking floor and the top surface 24a of the subfloor. Spacing means is configured to ensure the air channel 28 is in fluid communication with the openings 26 in the subfloor 24. This allows the flow of heated air upward from the burners 16 through the openings 26 in the subfloor 24 into the air channel 28. In this manner the gas burners 16 mounted to the oven housing 12 below the cooking chamber 14 have a flame region in fluid communication with the air channel 28. As shown in FIGS. 3 and 4, spacing means is provided by spacers 32, in the preferred embodiment namely metallic rods, fixedly attached to the top surface 24a of the subfloor.

To aid in controlling the temperature in the cooking chamber, the present invention is provided with a damper 52 positioned within an exhaust chimney 48. The damper 52 is closed when operating in the oven mode. In the preferred embodiment as shown on FIG. 2, the damper 52 is a circular disk that is inserted into a horizontal opening 49 formed in the side of the exhaust chimney 48. The disk has a centrally-located, circular opening 52a that is sized to allow a predetermined amount of heated air to exit the cooking chamber through the exhaust chimney when the damper is closed (i.e., when it is placed inside the exhaust chimney). For ease of use, the damper 52 is pivotally connected to the chimney where it can be manually rotated into position inside the chimney 48 when operating in the oven mode. In all other modes, including the grilling modes and the fireplace mode, the damper 52 is opened.

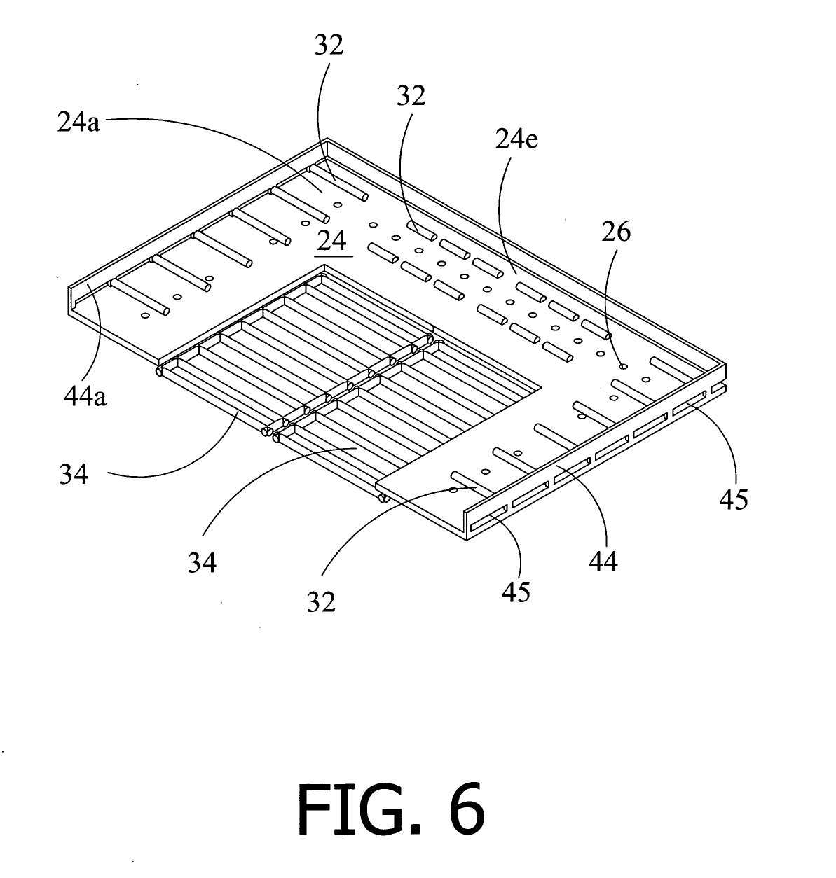

In addition to use as an oven, the present invention may also be readily converted and used as a traditional gas grill. Conversion of the invention from the oven mode to the grill mode is accomplished by simply removing the cooking tiles 22 and the insert portion 24c of the subfloor from the oven 10. The present invention provides means for supporting at least one removable grill rack 34 above the burners 16. The grill rack 34 is removable to allow for cleaning. The grill rack 34 has an upper surface 34a for grilling food within the cooking chamber 14. In the preferred embodiment, means for supporting the grill rack 34 is provided by the subfloor 24 upon a portion of which the grill rack 34 rests, or as shown in FIG. 6 the grill rack 34 is positioned just below the inner edges of the subfloor outer portion 24d. In either configuration, whether the outer edges of the grill rack 34 rest on the inner edges of the subfloor outer portion 24d or just below these inner edges, the grill rack 34 is positioned to cover the opening in the subfloor formed upon removal of the insert portions 22c of the subfloor. In this manner, the grill rack 34 is in the proper relationship to the burners 16 to allow the oven 10 to be used for traditional grilling. In the preferred embodiment, the grill rack 34 is therefore positioned below the insert portions 24c of the subfloor when the invention is operated in the oven mode. This allows the invention to be setup for use in the grilling mode simply upon removal of the cooking tiles 22 and the insert portion 24c of the subfloor. In the gas grill mode, the oven door 20 is removed from the oven housing 12, the damper 52 is opened, and the burners 16 are not used.

The outdoor oven of the present invention is provided with thermostatic means well known in the art for controlling the temperature in the cooking chamber 14 when used in the oven mode. A thermostat (not shown) is operatively connected to the burners 16 for use in adjusting the heat output of the burners 16 as needed to maintain a constant temperature in the cooking chamber 14. The present invention also comprises means for lighting the burner comprising an igniter button 58, shown in FIG. 1, and means for setting the desired temperature in the cooking chamber comprising an oven temperature control knob 54. The present invention may also include a temperature gauge 60, as seen in FIG. 1, mounted on the outer surface of the oven housing 12 for use in visually determining the current temperature in the cooking chamber 14. For use of the oven in the gas grill mode, the oven is provided with means for manually controlling the flow of gas to the burners 16 comprising one or more burner control knobs 56. In the preferred embodiment, the oven 10 is provided with three burners 16 and three burner control knobs 56, each of which controls the flow of gas to one of the burners 16.

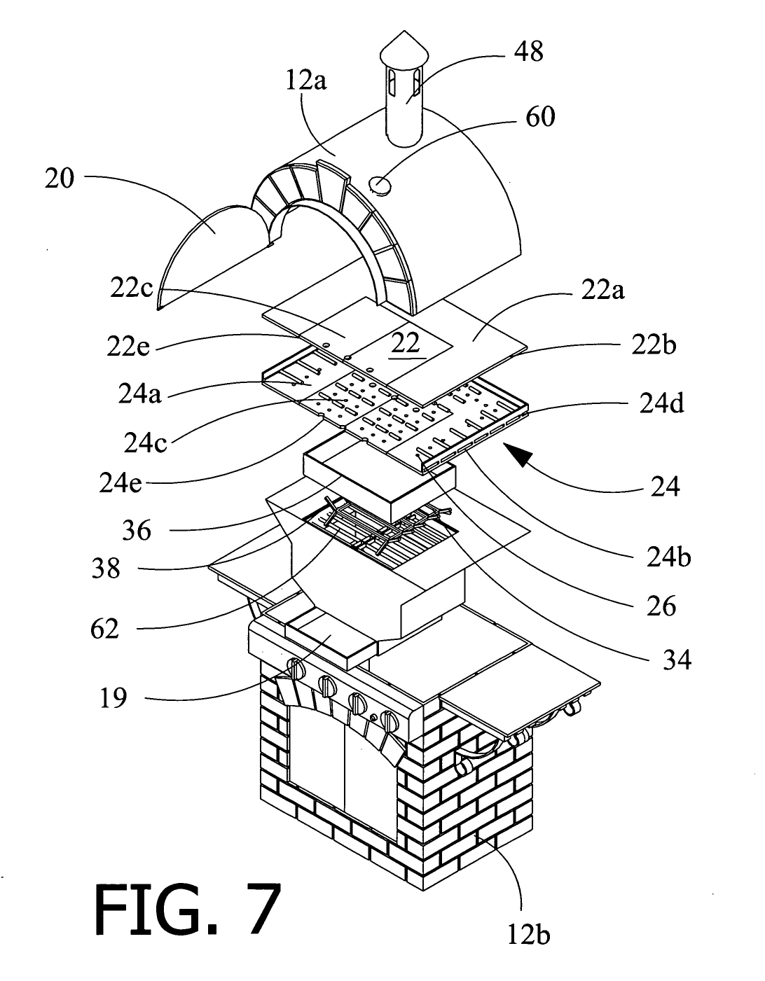

The present invention may also be converted for use as a traditional charcoal grill. The invention provides means for holding a metal box 36 between the burners 16 and the grill rack 34. In the preferred embodiment, means for holding comprises a removable charcoal box rack 38 inserted into the burner box 17 below the grill rack 34 onto which the metal box 36 is placed. The charcoal box rack 38 and metal box 36 are shown in FIG. 7. FIG. 7 also shows use of a flame rack positioned above the burners 16 which may be used as support for the charcoal box rack 38 when the burners 16 are not in use or, alternatively, for the disbursement of flame and heat when the burners are in use. In the charcoal mode the burners 16 are not used, the door 20 is removed, and the damper 52 is closed. Charcoal (not shown) is placed in the metal box 36 and lit for use as the heat source in grilling food on the grill rack 34 positioned above the metal box 36. After cooking, the metal box 36 is removed from the oven 10 for cleaning and to allow the oven to be reconfigured for use in other modes.

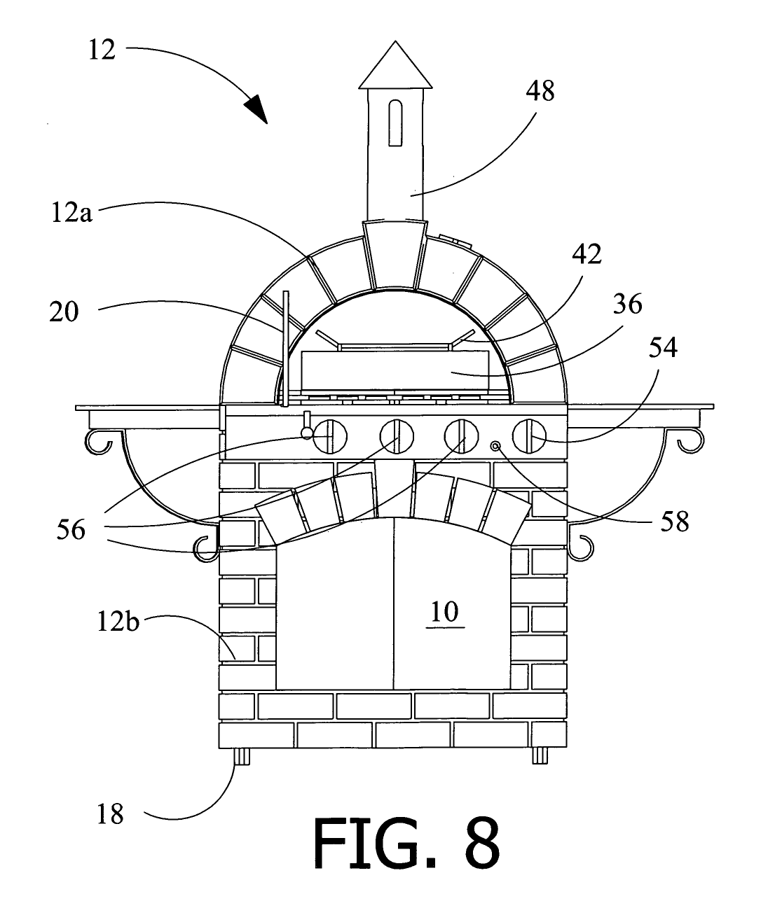

The present invention may also be used as an outdoor fireplace. With the cooking floor 22 in place, the present invention further comprises a removable log rack 42 positioned within the cooking chamber 14 above the floor 22. Wood and other materials may be placed on the log rack 42 to create a fire within the cooking chamber 14. In this fireplace mode, the burners 16 are not operated, the oven door 20 is removed and the damper 52 is closed. This allows light and heat from the fire to emanate outside from the oven 10 through the open oven door 20. As shown in FIG. 8, the log rack 42 is placed inside a metal box 36 that is used to collect ashes and debris.

When the present invention is used in the oven mode, the cooking tiles 22 comprising the floor are positioned on the upper surface of the spacers 32 as shown in FIG. 5. The space between the subfloor 24 and cooking floor 22 is maintained along the outer edge 24e of the cooking floor to allow heated air to flow from the air channel 28 through a plurality of slots 45 formed in the lip member at a height between the cooking floor 22 and the subfloor 24, as seen in FIG. 4. This may also be accomplished by resting or affixing the bottom surface of the lip member 44 to the top surface of the spacers 32 so that the spacing means maintains the lip member 44 itself apart from the subfloor 24 in a manner similar as the cooking floor 22.

As shown in FIG. 3, when the present invention is operated in the oven mode, heated air rises from the burners 16 and through openings 26 in the subfloor and into an air channel 28 bounded in the vertical direction by the bottom surface 22b of the cooking floor and the upper surface 24a of the subfloor. The heated air is directed in this manner to the bottom surface 22b of the ceramic tiles that form the cooking surface whereupon the cooking surface 22 is heated. The burners 16 are located within a burner box 17 positioned below the subfloor 24 which is adapted for directing the flow of heated air upward from the burners 16 to the openings 26 in the subfloor. The burner box 17 is open on top with the top edges being in sealing contact with the bottom 24b of the subfloor to direct heated air upward through the openings 26 in the subfloor. It may be appreciated that internal structures in the burner box 17 may have one or more internal holes 17a or voids as generally shown in FIGS. 2 and 3 to allow heated air to be in fluid communication with the openings 26 in the subfloor so that the heated air exits the burner box 17 through the openings, as is dictated by the internal configuration of the burner box 17. Having entered the air channel 28, the heated air then emanates outward through the air channel towards the outer edge 22e of the cooking floor, where it exits the air channel 28. The heated air exits the air channel 28 either through slots 45 formed in the lip member 44 at a height between the top of the subfloor 24a and the bottom 22b of the cooking tiles, or alternatively under the lip member 44. Upon exiting the air channel 28, the heated air then moves upward through the passageway 46 between the lip member 44 and the wall or inner surface 14a of the cooking chamber, whereupon the cooking chamber 14 is subsequently heated. The heated air maintains the cooking temperature in the cooking chamber 14 before it exits the oven through a chimney 48 formed in an upper portion of the cooking chamber.

A lip member 44 mounted within the chamber 14 is provided, as shown on FIGS. 2 and 3. The lip member 44 is mounted in spaced apart relationship to wall or the inner surface 14a of the cooking chamber to form a passageway 46 therebetween. It may be seen with reference to the drawings that in the preferred embodiment the lip member 44 is u-shaped. It is contemplated that lip members 44 having other configurations such as circular may be used without departing from the scope of the invention. The cooking floor 22 is positioned within the lip member 44 with the outer edge 22e of the floor being in conforming contact with the inner edge 44a of the lip member. The cooking floor 22 may be single tile shaped to fit in conforming contact with the lip member 44. Alternatively, the cooking floor 22 may comprise a plurality of removable cooking tiles 22 that are shaped to fit within the lip member 44. The lip member 44 assists in holding the cooking tiles 22 in abutting relationship to provide for a substantially contiguous cooking surface 22a. It may be appreciated that the lip member 44, a portion of which rises above the top of the cooking surface 22a, provides a barrier to prevent food from falling off the cooking surface 22a along its edge downward into the oven housing 12 or gas burner box 17. The lip member 44 rises above the cooking surface 22a at least about one inch and preferably at least about two inches. The lip member 44 also serves to hold the plurality of cooking tiles 22 in abutting relationship to one another to provide for a substantially contiguous cooking surface.

As shown in FIG. 3, when the present invention is operated in the oven mode, heated air rises from the burners 16, through the openings 26 in the subfloor, and into the air channel 28 below the cooking floor 22 to heat the cooking tiles. The heated air then emanates outward toward the outer edge 22e of the cooking floor. The heated air exits the air channel 28 proximate the outer edges (22e, 24e) of the cooking floor and subfloor and either under or through the lip member 44. The heated air then travels through the passageway 46 between the inner surface 14a of the cooking chamber and the lip member 44 and into the cooking chamber 14. The flow of heated air the exits the cooking chamber 14 of the oven 10 through the chimney 48.

It may be seen that the present invention provides for an outdoor oven 10 comprising a cooking chamber 14, at least one gas burner 16 positioned below the cooking chamber 14, a thermostat (not shown) operatively connected to the burners 16 for controlling the temperature of the cooking chamber 14, means for supporting at least one removable grill rack 34 above the burners 16 wherein the grill rack 34 has an upper surface 34a for grilling food within the cooking chamber 14, and means for positioning at least one removable cooking tile 22 above the burners 16 wherein the cooking tile 22 has an upper surface 22a for baking food within the cooking chamber 14.

It is to be understood that the form of the invention shown is a preferred embodiment thereof and that various changes and modifications may be made therein without departing from the spirit of the invention or the scope as defined in the following claims.

What is claimed is:

1. An outdoor oven comprising,
a housing having an upper portion forming a cooking chamber and a lower portion,
at least one gas burner positioned within said housing below said cooking chamber,
a metallic oven subfloor mounted to said housing between said burner and said chamber, said subfloor having a plurality of openings formed therein and an upper surface, wherein said subfloor comprises at least one removable insert portion and an outer portion,
a ceramic floor positioned above said subfloor wherein said floor comprises at least one removable cooking tile having a bottom surface and an upper cooking surface,
spacing means for creating an air channel between said bottom surface of said floor and said top surface of said subfloor, wherein said air channel is in fluid communication with said plurality of said openings, and
at least one grill rack positioned between said at least one burner and said insert portion for use in grilling food when said insert portion and said floor are removed from said oven.

2. An outdoor oven as described in claim 1 further comprising a thermostat operatively connected to said burner for controlling the temperature in said cooking chamber.

3. An outdoor oven as described in claim 1 further comprising means for holding a metal box between said burner and said grill rack.

4. An outdoor oven as described in claim 3 wherein said means for holding comprises a removable charcoal box rack.

5. An outdoor oven as described in claim 1 wherein said spacing means comprises spacers fixedly attached to the top surface of said subfloor.

6. An outdoor oven as described in claim 2 wherein said spacers are designed to provide the required flow of heat.

7. An outdoor oven as described in claim 1 wherein said housing is moveable.

8. An outdoor oven as described in claim 1 further comprising a removable log rack positioned within said cooking chamber above said floor.

9. An outdoor oven as described in claim 1 wherein said outer portion of said subfloor is u-shaped.

10. An outdoor oven comprising a cooking chamber, at least one gas burner positioned below said cooking chamber, a thermostat operatively connected to said burner for controlling the temperature of said cooking chamber, means for supporting at least one removable grill rack above said burner wherein said grill rack has an upper surface for grilling food within said cooking chamber, and means for positioning at least one removable cooking tile above said burner wherein said cooking tile has an upper surface for baking food within said cooking chamber.

11. An outdoor oven as described in claim 10 wherein said means for supporting comprises a subfloor having a plurality of openings formed therein.

12. An outdoor oven as described in claim 11 wherein said oven further comprises spacing means for positioning said at least one tile in spaced apart relationship from said subfloor to create an air channel therebetween.

13. An outdoor oven as described in claim 12 wherein said spacing means comprises spacers fixedly attached to a top surface of said subfloor.

14. An outdoor oven as described in claim 11 wherein said subfloor comprises at least one removable insert portion.

15. An outdoor oven as described in claim 10 further comprising means for holding a metal box between said burner and said grill rack.

16. An outdoor oven as described in claim 15 wherein said means for holding comprises a removable charcoal box rack.

17. An outdoor oven as described in claim 10 wherein said oven comprises at least two wheels for relocating said oven.

18. An outdoor oven as described in claim 10 further comprising a removable log rack positioned within said cooking chamber above said at least one tile.

19. An outdoor oven as described in claim 17 further comprising lightweight insulating material surrounding the top and sides of said cooking chamber.

20. An outdoor oven having a cooking chamber with an inner surface, a lip member mounted within said chamber in spaced apart relationship to said inner surface to form a passageway therebetween, a cooking floor positioned within said lip, said floor having an outer edge in conforming contact with an inner edge of said lip, and a subfloor positioned below said floor to form an air channel therebetween wherein said air channel is in fluid communication with said passageway.

21. An outdoor oven as described in claim 20 wherein said floor comprises a plurality of removable cooking tiles.

22. An outdoor oven as described in claim 21 wherein said floor has a substantially contiguous upper cooking surface.

23. An outdoor oven as described in claim 20 further comprising a moveable housing.

24. An outdoor oven as described in claim 23 further comprising lightweight insulating material surrounding the top and sides of said cooking chamber.

25. An outdoor oven as described in claim 20 further comprising at least one gas burner mounted to said housing below said cooking chamber, said burner having a flame region in fluid communication with said air channel.

26. An outdoor oven as described in claim 20 further comprising means for controlling the temperature in said cooking chamber.

27. An outdoor oven as described in claim 26 wherein said controlling means comprises a thermostat operatively connected to said burner.

28. An outdoor oven as described in claim 20 wherein said subfloor comprises at least one centrally-located removable insert portion and an outer portion.

29. An outdoor oven as described in claim 28 wherein said outer portion is u-shaped.

30. An outdoor oven as described in claim 20 further comprising a removable log rack positioned within said cooking chamber above said ceramic floor.
